(19) United States
(12) Patent Application Publication
(10) Pub. No.: US 2016/0192000 A1
(43) Pub. Date: Jun. 30, 2016

(54) INTERACTIVE DISPLAY SYSTEM AND OPERATION METHOD THEREOF

(71) Applicant: Coretronic Corporation, Hsin-Chu (TW)

(72) Inventors: Pen-Ning Kuo, Hsin-Chu (TW); Chung-Lung Yang, Hsin-Chu (TW); Nan-Jiun Yin, Hsin-Chu (TW)

(21) Appl. No.: 14/803,121

(22) Filed: Jul. 20, 2015

(30) Foreign Application Priority Data
Dec. 31, 2014 (CN) 201410849029.7

(51) Int. Cl. H04N 21/462; H04N 21/426; H04N 21/472

(52) U.S. Cl. CPC H04N 21/4622; H04N 21/47202; H04N 21/4263

(57) ABSTRACT

An interactive display system includes a video disposition circuit, a display module, an event detection module, an event processing circuit, and a position determination circuit. The video disposition circuit receives different video frames of video source apparatuses, disposes the video frames in a display frame, and outputs frame disposition information. The display module receives and displays the display frame. The event detection module senses an interactive event in the display frame and generates a detection signal. The event processing circuit generates interactive position information according to the detection signal. The position determination circuit selects a corresponding video source apparatus from the video source apparatuses according to the interactive position information and the frame disposition information, and sends event coordinate data corresponding to the interactive position information to the corresponding video source apparatus. An operation method of an interactive display system is also provided.

### CROSS-REFERENCE TO RELATED APPLICATION

This application claims the priority benefit of China application serial no. 201410849029.7, filed on Dec. 31, 2014. The entirety of the above-mentioned patent application is hereby incorporated by reference herein and made a part of this specification.

### BACKGROUND OF THE INVENTION

1. Field of the Invention

The invention relates to a display system, and more particularly, to an interactive display system and an operation method thereof.

2. Description of Related Art

As the size of the display apparatus increases, a visual range also becomes larger. A video source apparatus can display a video on a display apparatus, and the display apparatus can have interactive function to provide interaction with the user and other viewers. In the current techniques, when a plurality of video source apparatuses need to display videos on the same display apparatus, the video cable needs to be manually plugged/unplugged between the different video source apparatuses and the display apparatus to switch the video sources. Moreover, the conventional display apparatus cannot yet perform interactive operation with a plurality of different video source apparatuses at the same time.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### SUMMARY OF THE INVENTION

The invention provides an interactive display system and an operation method thereof capable of achieving interactive operation between the same display frame and a plurality of video source apparatuses.

Other objects and advantages of the invention can be further illustrated by the technical features broadly embodied and described as follows.

In order to achieve one or a part of or all of the above advantages or other advantages, an embodiment of the invention discloses an interactive display system to receive and display a plurality of video frames from a plurality of video source apparatuses. The interactive display system includes a video disposition circuit, a display module, an event detection module, an event processing circuit, and a position determination circuit. The video disposition circuit is adapted to receive the plurality of video frames respectively from the plurality of video source apparatuses, dispose the plurality of the video frames into a display frame, and output frame disposition information. The display module is coupled to the video disposition circuit to receive and display the display frame. The event detection module is adapted to sense an interactive event in the display frame and generates a detection signal. The event processing circuit is coupled to the event detection module to receive and process the detection signal to generate interactive position information according to the detection signal. The position determination circuit is coupled to the event processing circuit and the video disposition circuit to respectively receive the interactive position information and the frame disposition information. The position determination circuit is adapted to select one corresponding video source apparatus from the plurality of video source apparatuses according to the interactive position information and the frame disposition information, and to send event coordinate data corresponding to the interactive position information to the corresponding video source apparatus.

In an embodiment of the invention, the video disposition circuit is adapted to divide the display frame into a plurality of sub-regions not overlapped with one another, and the plurality of video frames of the plurality of video source apparatuses are disposed in the plurality of sub-regions in a one-to-one manner when the video disposition circuit receives the plurality of video frames respectively from the plurality of video source apparatuses.

In an embodiment of the invention, when the interactive position information indicates that a position of the interactive event is located in a corresponding sub-region of the plurality of sub-regions, the position determination circuit is adapted to send the event coordinate data to the corresponding video source apparatus corresponding to the corresponding sub-region.

In an embodiment of the invention, wherein the video disposition circuit is adapted to define a plurality of stackable windows in the display frame, and the plurality of video frames respectively from the plurality of video source apparatuses are disposed in the plurality of stackable windows in a one-to-one manner when the video disposition circuit receives the plurality of video frames respectively from the plurality of video source apparatuses.

In an embodiment of the invention, the video disposition circuit is adapted to define a plurality of stackable windows in the display frame, and the plurality of video frames of the plurality respectively from video source apparatuses are disposed in the plurality of stackable windows in a one-to-one manner when the video disposition circuit receives the plurality of video frames respectively from the plurality of video source apparatuses.

In an embodiment of the invention, the video disposition circuit is adapted to further receive the interactive position information and select a corresponding window from the plurality of stackable windows as an active window according to the interactive position information, wherein when at least part of the corresponding window is covered under other window in the plurality of stackable windows, the video disposition circuit is adapted to pull the corresponding window to a topmost layer in the plurality of stackable windows.

In an embodiment of the invention, the interactive position information represents a position of the interactive event in a coordinate space of the display frame.

In an embodiment of the invention, the position determination circuit is adapted to convert the interactive position information belonging to the coordinate space of the display frame into the event coordinate data belonging to a coordinate space of the video frame of the corresponding video source apparatus.

In an embodiment of the invention, the display module comprises a display screen to receive and display the display frame, and the event detection module further comprises a touch panel to sense the interactive event in the display frame so as to obtain the detection signal.

In an embodiment of the invention, the display module comprises a projection module to receive and display the display frame, and the event detection module further comprises a touch projection screen to sense the interactive event in the display frame so as to obtain the detection signal.

In order to achieve one or a part of or all of the above advantages or other advantages, an embodiment of the invention discloses an operation method of an interactive display system. The interactive display system includes a video disposition circuit, a display module, an event detection module, an event processing circuit, and a position determination circuit. The operation method of the interactive display system includes the following steps. Different video frames respectively from a plurality of video source apparatuses are received by the video disposition circuit. The video frames are disposed in the display frame by the video disposition circuit, and frame disposition information is outputted. A display frame is received and displayed by the display module. An interactive event in the display frame is sensed by the event detection module and a detection signal is generated. Interactive position information is generated according to the detection signal by the event processing circuit. A corresponding video source apparatus is selected from the video source apparatuses according to the interactive position information and the frame disposition information by the position determination circuit, and event coordinate data corresponding to the interactive position information is sent to the corresponding video source apparatus.

In an embodiment of the invention, the display frame is divided into a plurality of sub-regions not overlapped with one another by the video disposition circuit. The video frames respectively from the plurality of video source apparatuses are disposed into the plurality of sub-regions in a one-to-one manner by the video disposition circuit.

In an embodiment of the invention, when the interactive position information indicates that a position of the interactive event is located in a corresponding sub-region of the plurality of sub-regions, the event coordinate data is sent to the corresponding video source apparatus corresponding to the corresponding sub-region by the position determination circuit.

In an embodiment of the invention, the video disposition circuit defines multiple stackable windows in the display frame. Video frames respectively from the plurality of video source apparatuses are disposed into the multiple stackable windows in a one-to-one manner by the video disposition circuit.

In an embodiment of the invention, the interactive position information is received by the video disposition circuit. A corresponding window is selected from the multiple stackable windows as an active window according to the interactive position information by the video disposition circuit. The corresponding window is pulled to a topmost layer in the multiple stackable windows by the video disposition circuit when at least part of the corresponding window is covered under other window in the multiple stackable windows.

In an embodiment of the invention, when the interactive position information indicates that a position of the interactive event is located in a corresponding window of the multiple stackable windows, the event coordinate data is sent to the corresponding video source apparatus corresponding to the corresponding window by the position determination circuit.

In an embodiment of the invention, the interactive position information represents a position of the interactive event in a coordinate space of the display frame. The interactive position information belonging to the coordinate space of the display frame is converted into the event coordinate data belonging to a coordinate space of the video frame of the corresponding video source apparatus by the position determination circuit.

In order to achieve one or a part of or all of the above advantages or other advantages, an embodiment of the invention discloses an operation method of an interactive display system. The interactive display system includes a video disposition circuit, a display module, an event detection module, an event processing circuit, and a position determination circuit. The operation method of the interactive display system includes the following steps. At least one video frame from at least one video source apparatus is received by the video disposition circuit. The at least one video frame is disposed in the display frame by the video disposition circuit, and frame disposition information is outputted. The video disposition circuit detects whether there are multiple video frames respectively from multiple video source apparatus. The display frame is received and displayed by the display module. An interactive event in the display frame is sensed by the event detection module and a detection signal is generated. Interactive position information is generated according to the detection signal by the event processing circuit. The interactive position information represents a position of the interactive event in a coordinate space of the display frame. A corresponding video source apparatus is selected from the video source apparatuses according to the interactive position information and the frame disposition information by the position determination circuit when detecting there are multiple video frames respectively from the plurality of video source apparatuses. The interactive position information belonging to the coordinate space of the display frame is converted into event coordinate data belonging to a coordinate space of the video frame of the corresponding video source apparatus by the position determination circuit. Event coordinate data corresponding to the interactive position information is sent to the corresponding video source apparatus.

The interactive display system and the operation method thereof of one or more embodiments of the invention can dispose different video frames respectively from a plurality of video source apparatuses in the same display frame. When the interactive display system senses an interactive event in the display frame, the interactive display system selects the corresponding video source apparatus corresponding to the interactive event according to the interactive position information (e.g. the occurrence position of the interactive event) and the frame disposition information of the display frame (e.g. the disposition status of different video frames in the display frame), and sends the event coordinate data of the interactive event to the corresponding video source apparatus, so as to respond to the interactive operation performed by the user for different video source apparatuses in the same display frame.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit schematic block diagram of an interactive display system according to an embodiment of the invention.

FIG. 2 is a schematic diagram of a display frame according to an embodiment of the invention.

FIG. 3 is a circuit schematic block diagram of an interactive display system according to another embodiment of the invention.

FIG. 4 is a schematic diagram of a display frame according to another embodiment of the invention.

FIG. 5 is a process schematic diagram of an interactive display method according to an embodiment of the invention.

FIG. 6 is a process schematic diagram of the steps of an interactive display method according to an embodiment of the invention.

### DESCRIPTION OF THE EMBODIMENTS

It is to be understood that both the foregoing and other detailed descriptions, features and advantages are intended to be described more comprehensively by providing preferred embodiments accompanied with figures hereinafter. The drawings and descriptions will be regarded as illustrative in nature and not as restrictive. The use of “including”, “comprising”, or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

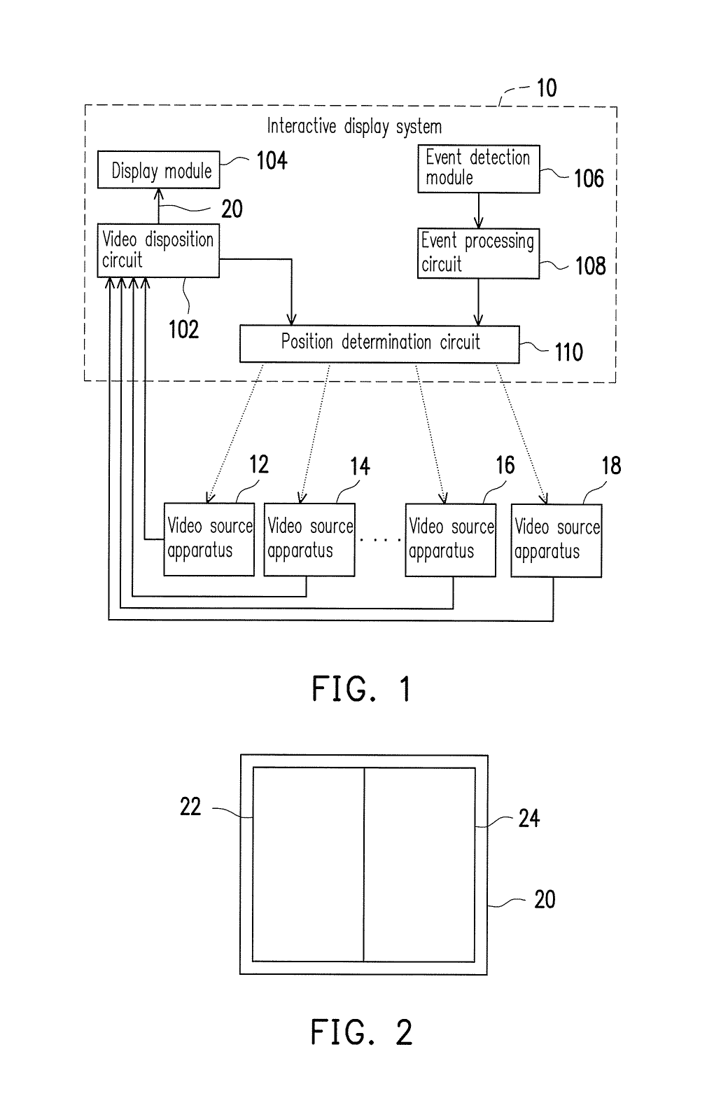

FIG. 1 is a circuit schematic block diagram of an interactive display system exemplarily illustrated according to an embodiment of the invention. Referring to FIG. 1, an interactive display system 10 can be connected to a plurality of video source apparatuses (such as video source apparatuses 12, 14, 16, and 18 exemplarily shown in FIG. 1) via a wired and/or wireless method. The number of the video source apparatus can be decided according to design requirements and/or application requirements, and the invention is not limited thereto. The interactive display system 10 contains, for instance, a combination of a projector and an interactive projection screen, or contains a touch display. The interactive display system 10 can receive and display video frames from a plurality of video source apparatuses 12, 14, 16, and 18. The video source apparatuses 12, 14, 16, and 18 are, for instance, personal computers, notebook computers, tablet computers, mobile phones, set-top boxes, or other video source apparatuses, and the invention does not limit the type and configuration of the video source apparatuses.

In the present embodiment, the interactive display system 10 includes a video disposition circuit 102, a display module 104, an event detection module 106, an event processing circuit 108, and a position determination circuit 110.

The video source apparatuses 12, 14, 16, and 18 can send a video frame to the video disposition circuit 102 respectively via a wired method and/or a wireless method. According to different design requirements, the wired method includes local area network (LAN), high-definition multimedia interface (HDMI), digital visual interface (DVI), universal serial bus (USB), and/or other suitable video transmission interfaces. The wireless method includes wireless LAN (WLAN), wireless fidelity (Wi-Fi), blue tooth, or other suitable wireless transmission interfaces. The video disposition circuit 102 is used to receive video frames from each of the video source apparatuses 12, 14, 16, and 18, and to dispose the video frames in a display frame 20. For instance, the video disposition circuit 102 can embed a plurality of video frames in the same display frame 20, such that the video frames become different sub-frames (or different windows) of the display frame 20. In one embodiment, the video disposition circuit 102 can further output frame disposition information, wherein the frame disposition information contains the disposition status (i.e., layout status) of the video frames disposed in the display frame 20. The frame disposition information can contain, for instance, the number of the video source apparatuses, the number of the video frames, the video source apparatus corresponding to the certain video frame, the format of disposition, the position of the video frame, the size of the video frame, and/or other information, and the invention does not limit the contents contained in the frame disposition information.

The display module 104 is coupled to the video disposition circuit 102, and the display module 104 can receive and display the display frame 20. In some embodiments, the display module 104 projects the display frame 20 onto a projection screen (not shown) via, for instance, a projector (not shown) for users to view the display fame 20. In some other embodiments, the display module 104 displays the display frame 20 via, for instance, a touch display (such as a liquid crystal display, not shown) for users to view the display fame 20. The event detection module 106 can sense an interactive event of the user in the display frame 20, and correspondingly generate a detection signal.

In an embodiment, the display module 104 includes a display screen (such as a liquid crystal display, not shown), and is used to receive and display the display frame 20. The event detection module 106 further includes a touch panel (not shown), and can be disposed on the display region of the display screen in the display module 104, and the touch panel can sense an interactive event of the user in the display frame of the display region, and correspondingly generate/obtain a detection signal.

In another embodiment, the display module 104 includes a projector (not shown) used to receive and project the display frame 20. The event detection module 106 further includes a touch projection screen (not shown), such as a laser curtain module, and the display module 104 can project the display frame 20 to the sensing region of the touch projection screen in the event detection module 106 for users to view the display frame, and the touch projection screen can sense an interactive event of the user in the display frame of the sensing region, and correspondingly generate/obtain a detection signal.

The event processing circuit 108 is coupled to the event detection module 106, and the event processing circuit 108 can receive and process the detection signal generated by the event detection module 106. The event processing circuit 108 generates interactive position information according to the detection signal. The interactive position information can represent the position of an interactive event occurred in the coordinate space in the display frame 20. The event processing circuit 108 can be, for instance, an ASIC, a circuit board, a processor, or a central processing unit (CPU) configured to compute the position of the touch position by the user, by using appropriate algorithms, such as the triangulation, or by sensing, for example, the variation of capacitance, resistance, or electromagnetic field on or near the interactive position to generates interactive position information, depending on which kinds of event detection module 106 is used.

The position determination circuit 110 is coupled to the video disposition circuit 102 to receive frame disposition information, and is coupled to the event processing circuit 108 to receive interactive position information. The present embodiment does not limit the implementation of the position determination circuit 110, and the position determination circuit 110 can contain, for instance, a central processing unit (CPU), a chipset, a system-on-chip (SoC), a circuit board, an ASIC, or other circuits having computing capabilities. In some other embodiments, the video disposition circuit 102 and/or the position determination circuit 110 can be servers, personal computers, notebook computers, tablet computers, or other electronic apparatuses having computing capabilities, and the invention does not limit the type and configuration of the video disposition circuit 102 and the position determination circuit 110.

The position determination circuit 110 can respectively receive the frame disposition information outputted by the video disposition circuit 102 and the interactive position information generated by the event processing circuit 108, and select one corresponding video source apparatus from the video source apparatuses 12, 14, 16, and 18 according to the interactive position information and the frame disposition information, and send the event coordinate data corresponding to the interactive position information to the corresponding video source apparatus. The position determination circuit 110 can send the event coordinate data to the corresponding video source apparatus via a wired method and/or wireless method. According to different design requirements, the wired method includes LAN, USB, and/or other suitable transmission interfaces, and the wireless method includes bluetooth, Wi-Fi, or other suitable wireless transmission interfaces.

In some embodiments, the position determination circuit 110 converts the interactive position information belonging to the coordinate space of the display frame 20 into the event coordinate data belonging to the coordinate space of the video frame of the corresponding video source apparatus according to the frame disposition information. In some other embodiments, the position determination circuit 110 can use the interactive position information belonging to the coordinate space of the display frame 20 as the event coordinate data, and send the event coordinate data to the corresponding video source apparatus. In some embodiments, the video disposition circuit 102 can contain the position determination circuit 110.

In some embodiments (but not limited thereto), the video disposition circuit 102 can divide one display frame 20 into a plurality of sub-regions not overlapped with one another, and different video frames respectively from the video source apparatuses 12, 14, 16, and 18 are disposed in the sub-regions in a one-to-one manner. When the interactive position information of the event processing circuit 108 indicates that the position of the interactive event is located in one corresponding sub-region in the sub-regions, the position determination circuit 110 can send the event coordinate data to the video source apparatus corresponding to the corresponding sub-region.

For instance, FIG. 2 is a schematic diagram of the display frame 20 according to an embodiment of the invention. Referring to FIG. 1 and FIG. 2, the display frame 20 is, for instance, divided into two sub-regions not overlapped with each other, which are respectively a left sub-region 22 and a right sub-region 24. However, the invention is not limited thereto, and the number, dimension, shape, etc. of the sub-regions of the display frame 20 can be modified according to usage requirement and the number of the video source apparatuses. In the present embodiment, the video disposition circuit 102 receives, for instance, the video frames from the video source apparatuses 12 and 14. The video disposition circuit 102 can dispose the video frames outputted by the video source apparatus 12 in the sub-region 22, and the video disposition circuit 102 can dispose the video frames outputted by the video source apparatus 14 in the sub-region 24. The video disposition circuit 102 outputs the display frame 20 having the video frames of the video source apparatuses 12 and 14 to the display module 104. The display module 104 can display the display frame 20 to the user for viewing. Moreover, the video disposition circuit 102 can output frame disposition information to the position determination circuit 110.

When an interactive event occurs to the display frame 20 (such as the user performs an interactive operation on a touch projection screen or a touch display via a finger, a stylus pen, or an infrared pen), the event detection module 106 can generate a detection signal and send the detection signal to the event processing circuit 108. The event processing circuit 108 can process the detection signal and correspondingly generate interactive position information, wherein the interactive position information belongs to the coordinate space of the display frame 20. For instance, when the user touches the sub-region 22, the event detection module 106 can generate a detection signal and send the detection signal to the event processing circuit 108, and the event processing circuit 108 can process the detection signal and correspondingly generate interactive position information. Then, the position determination circuit 110 can determine the interactive event occurs in the sub-region 22 of the display frame 20 according to the frame disposition information outputted by the video disposition circuit 102 and according to the interactive position information generated by the event processing circuit 108. Therefore, the position determination circuit 110 can select the video source apparatus 12 corresponding to the sub-region 22 from the video source apparatuses 12 and 14. The position determination circuit 110 then converts the interactive position information into the event coordinate data belonging to the coordinate space of the video frame of the corresponding video source apparatus 12, and sends the event coordinate data to the video source apparatus 12. Therefore, the video source apparatus 12 can perform an interactive operation according to the event coordinate data and output a new video frame to the sub-region 22, so as to respond to the interactive event of the user in the display frame 20.

FIG. 3 is a circuit schematic block diagram of an interactive display system 30 according to another embodiment of the invention. Referring to FIG. 3, the implementation of the interactive display system 30, each of the video source apparatuses (32, 34, 36, and 38), the video disposition circuit 302, the display module 304, the event detection module 306, the event processing circuit 308, and the position determination circuit 310 in the present embodiment are similar to the interactive display system 10, each of the video source apparatuses (i.e., the video source apparatuses 12, 14, 16, and 18 shown in FIG. 1), the video disposition circuit 102, the display module 104, the event detection module 106, the event processing circuit 108, and the position determination circuit 110, and are not repeated herein. In the present embodiment, the position determination circuit 310 can also output the interactive position information to the video disposition circuit 302.

In the present embodiment, the video disposition circuit 302 can define a plurality of stackable windows in a display frame 40. The video disposition circuit 302 can dispose different video frames respectively from a plurality of video source apparatuses (such as video source apparatuses 32, 34, 36, and 38) in the stackable windows in a one-to-one manner. In one embodiment, the video disposition circuit 302 further receives the interactive position information provided by the position determination circuit 310. According to the interactive position information, the video disposition circuit 302 can determine which of the stackable windows that the position of the interactive event is located in, and thereby select the corresponding window (i.e., the window in which the interactive event occurs) from the stackable windows as an active window. When at least part of the corresponding window (active window) is covered under other windows in the stackable windows, the video disposition circuit 302 can pull the corresponding window to the topmost layer in the stackable windows for the user to view.

The video disposition circuit 302 can also output frame disposition information to the position determination circuit 310. The position determination circuit 310 can learn which window in the stackable windows that the position of the interactive event is located in according to the frame disposition information outputted by the video disposition circuit 302 and according to the interactive position information generated by the event processing circuit 308. In other words, the position determination circuit 310 can judge or determine which window in the stackable windows that the position of the interactive event is located in according to the frame disposition information outputted by the video disposition circuit 302 and according to the interactive position information generated by the event processing circuit 308. When the interactive position information provided by the event processing circuit 308 indicates that the position of the interactive event is located in one corresponding window in the stackable windows, the position determination circuit 310 can send the event coordinate data to the video source apparatus corresponding to the corresponding window (i.e., window in which the interactive event occurs).

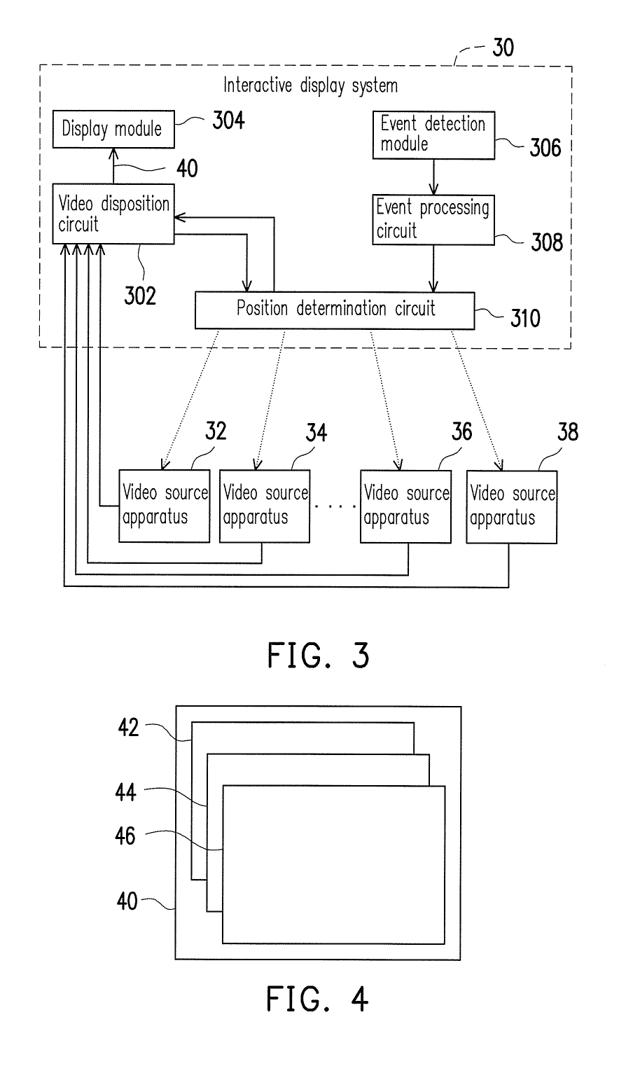

FIG. 4 is a schematic diagram of the display frame 40 according to another embodiment of the invention. Referring to FIG. 3 and FIG. 4, the display frame 40 includes a plurality of stackable windows 42, 44, and 46. In the present embodiment, the video disposition circuit 302 receives, for instance, the video frames from the video source apparatuses 32, 34, and 36, and disposes the video frames outputted by the video source apparatuses 32, 34, and 36 in the stackable windows 42, 44, and 46 of the display frame 40. The video disposition circuit 302 outputs the display frame 40 having the stackable windows 42, 44, and 46 to the display module 304. The display module 304 can display the display frame 40 to the user for viewing. FIG. 4 illustrates the last layer of the stackable window 42 located in the stackable windows, and the topmost layer of the stackable window 46 located in the stackable windows is an active window. The number, dimension, shape, etc. of the stackable windows in the display frame 40 can be modified according to usage requirement and the number of the video source apparatuses, and each of the stackable windows can also be divided into a plurality of sub-regions not overlapped with one another as exemplarily shown in the embodiment of FIG. 2, and the invention is not limited thereto.

For instance, when the user is to view the video frames of the stackable window 42, the user can touch the stackable window 42 in the display frame 40 (i.e., interactive event occurs). The video disposition circuit 302 can determine the position of the interactive event is located in the stackable window 42 according to the interactive position information provided by the position determination circuit 310, and thereby select the corresponding window 42 from the stackable windows as an active window. The video disposition circuit 302 can pull the corresponding window 42 to the topmost layer in the stackable windows for the user to view. At the same time, the position determination circuit 310 can learn that the stackable window 42 is touched by the user according to the interactive position information generated by the event processing circuit 308 and according to the frame disposition information outputted by the video disposition circuit 302, and learn the video frame in the stackable window 42 is from the video source apparatus 32. In other words, the position determination circuit 310 can judge or determine that the stackable window 42 is touched by the user according to the interactive position information generated by the event processing circuit 308 and according to the frame disposition information outputted by the video disposition circuit 302, and judge or determine that the video frame in the stackable window 42 is from the video source apparatus 32. Therefore, the position determination circuit 310 can convert the interactive position information into the event coordinate data belonging to the coordinate space of the video frame of the video source apparatus 32, and send the event coordinate data to the video source apparatus 32 corresponding to the stackable window 42. Therefore, the video source apparatus 32 can perform an interactive operation according to the event coordinate data and output a new video frame to the stackable window 42, so as to respond to the interactive operation of the user.

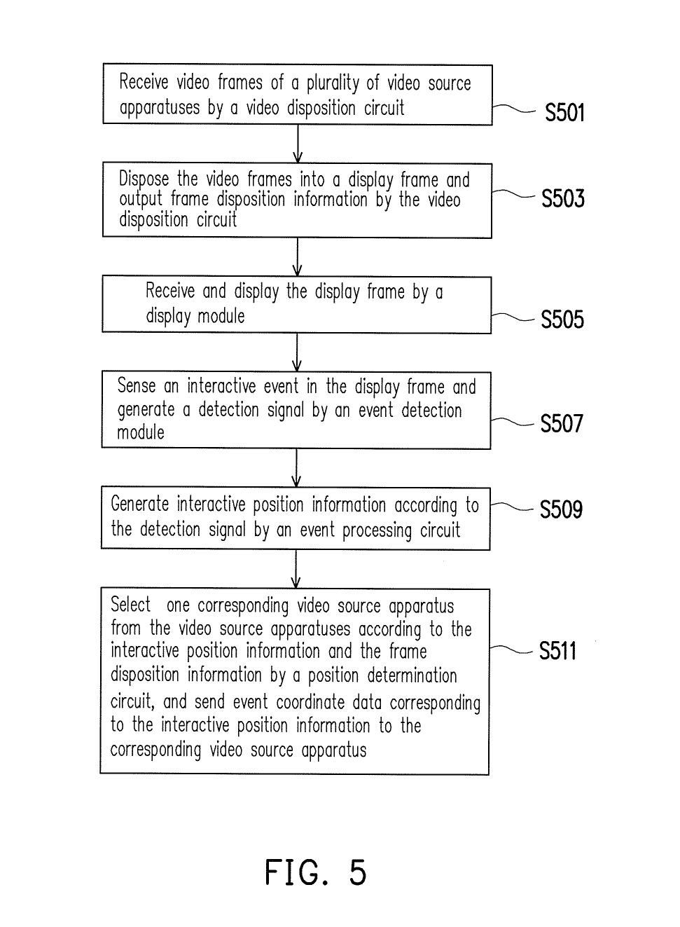

FIG. 5 is a process schematic diagram of an interactive display method according to an embodiment of the invention. The process shown in FIG. 5 can be applied in the embodiment shown in FIG. 1 or FIG. 3. In step S501, different video frames from a plurality of video source apparatuses are received by a video disposition circuit. In step S503, the video frames are disposed in a display frame by the video disposition circuit, and frame disposition information is outputted. In step S505, a display frame is received and displayed by a display module. In step S507, an interactive event in the display frame is sensed by an event detection module and a detection signal is correspondingly generated. In step S509, interactive position information is generated according to the detection signal by the event processing circuit. In step S511, one corresponding video source apparatus is selected from the video source apparatuses according to the interactive position information and the frame disposition information by the position determination circuit, and event coordinate data corresponding to the interactive position information is sent to the corresponding video source apparatus.

In an embodiment, the position determination circuit of the interactive display system can continuously detect whether the display frame contains the video frames of a plurality of video source apparatuses according to the frame disposition information. The position determination circuit can send the event coordinate data corresponding to the interactive position information to the corresponding video source apparatus according to the frame disposition information and the interactive position information.

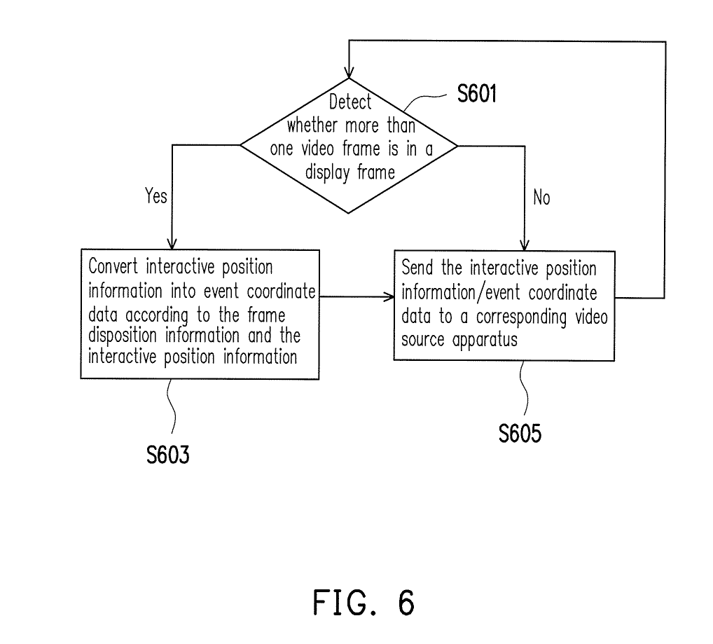

Specifically, FIG. 6 is a process schematic diagram of the steps of an interactive display method according to an embodiment of the invention. The process shown in FIG. 6 can be applied in the embodiment shown in FIG. 1 or FIG. 3. In step S601, a video disposition circuit can continuously detect whether more than one video frame is in a display frame. When the video disposition circuit determines more than one video frame is in the display frame in step S601, the position determination circuit selects one corresponding video source apparatus from the video source apparatuses according to the frame disposition information and the interactive position information in step S603, and converts the interactive position data into event coordinate data belonging to the coordinate space of the video frame of the corresponding video source apparatus. Then, step S605 is performed, in which the event coordinate data is sent to the corresponding video source apparatus.

When the video disposition circuit determines the display frame has the video frames from only one video source apparatus in step S601, the video disposition circuit directly executes step S605. In step S605, the event coordinate data corresponding to the interactive position information is sent to the video source apparatus via the position determination circuit. In some embodiments, the interactive position information can be directly used as the event coordinate data without a conversion process, so as to increase processing efficiency. In another embodiment, the position determination circuit can convert the interactive position information into the event coordinate data belonging to the coordinate space of the video frame of the corresponding video source apparatus, and send the event coordinate data to the corresponding video source apparatus.

The interactive display system and the operation method thereof of one or more embodiments of the invention can dispose different video frames respectively from a plurality of video source apparatuses in the same display frame. The method of disposition of the video frames can include a plurality of stackable windows, and/or a plurality of sub-regions not overlapped with one another. When an interactive event is detected to occur in the display frame, the interactive display system can select the corresponding video source apparatus according to the interactive position information and the frame disposition information of the display frame, and send the event coordinate data corresponding to the interactive position information to the corresponding video source apparatus. Therefore, the video source apparatuses can respond to an interactive event and perform an interactive operation, and do not require the user to manually plug/unplug a cable.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An interactive display system used to receive and display a plurality of video frames from a plurality of video source apparatuses, the interactive display system comprising:
a video disposition circuit, adapted to receive the plurality of video frames respectively from the plurality of video source apparatuses, dispose the plurality of video frames into a display frame, and output frame disposition information;
a display module, coupled to the video disposition circuit to receive and display the display frame;
an event detection module, adapted to sense an interactive event in the display frame and generate a detection signal;
an event processing circuit, coupled to the event detection module to receive and process the detection signal to generate interactive position information according to the detection signal; and
an position determination circuit, coupled to the event processing circuit and the video disposition circuit to respectively receive the interactive position information and the frame disposition information, wherein the position determination circuit is adapted to select a corresponding video source apparatus from the plurality of video source apparatuses according to the interactive position information and the frame disposition information, and to send event coordinate data corresponding to the interactive position information to the corresponding video source apparatus.

2. The interactive display system of claim 1, wherein the video disposition circuit is adapted to divide the display frame into a plurality of sub-regions not overlapped with one another, and the plurality of video frames of the plurality of video source apparatuses are disposed in the plurality of sub-regions in a one-to-one manner when the video disposition circuit receives the plurality of video frames respectively from the plurality of video source apparatuses.

3. The interactive display system of claim 2, wherein when the interactive position information indicates that a position of the interactive event is located in a corresponding sub-region of the plurality of sub-regions, the position determination circuit is adapted to send the event coordinate data to the corresponding video source apparatus corresponding to the corresponding sub-region.

4. The interactive display system of claim 1, wherein the video disposition circuit is adapted to define a plurality of stackable windows in the display frame, and the plurality of video frames respectively from the plurality of video source apparatuses are disposed in the plurality of stackable windows in a one-to-one manner when the video disposition circuit receives the plurality of video frames respectively from the plurality of video source apparatuses.

5. The interactive display system of claim 4, wherein the video disposition circuit is adapted to further receive the interactive position information and select a corresponding window from the plurality of stackable windows as an active window according to the interactive position information, wherein when at least part of the corresponding window is covered under other window in the plurality of stackable windows, the video disposition circuit is adapted to pull the corresponding window to a topmost layer in the plurality of stackable windows.

6. The interactive display system of claim 4, wherein when the interactive position information indicates that a position of the interactive event is located in a corresponding window of the plurality of stackable windows, the position determination circuit is adapted to send the event coordinate data to the corresponding video source apparatus corresponding to the corresponding window.

7. The interactive display system of claim 1, wherein the interactive position information represents a position of the interactive event in a coordinate space of the display frame.

8. The interactive display system of claim 7, wherein the position determination circuit is adapted to convert the interactive position information belonging to the coordinate space of the display frame into the event coordinate data belonging to a coordinate space of the video frame of the corresponding video source apparatus.

9. The interactive display system of claim 1, wherein the display module comprises a display screen to receive and display the display frame, and the event detection module further comprises a touch panel to sense the interactive event in the display frame so as to obtain the detection signal.

10. The interactive display system of claim 1, wherein the display module comprises a projection module to receive and display the display frame, and the event detection module further comprises a touch projection screen to sense the interactive event in the display frame so as to obtain the detection signal.

11. An operation method of an interactive display system, the interactive display system comprising a video disposition circuit, a display module, an event detection module, an event processing circuit, and a position determination circuit, the operation method comprising:
receiving a plurality of video frames respectively from a plurality of video source apparatuses by the video disposition circuit;
disposing the plurality of video frames into a display frame and outputting frame disposition information by the video disposition circuit;
receiving and displaying the display frame by the display module;
sensing an interactive event in the display frame and generating a detection signal by the event detection module;
generating interactive position information according to the detection signal by the event processing circuit; and
selecting a corresponding video source apparatus from the plurality of video source apparatuses according to the interactive position information and the frame disposition information by the position determination circuit, and sending event coordinate data corresponding to the interactive position information to the corresponding video source apparatus.

12. The operation method of claim 11, wherein the step of disposing the plurality of video frames into the display frame comprises:
dividing the display frame into a plurality of sub-regions not overlapped with one another by the video disposition circuit; and
disposing the plurality of video frames respectively from the plurality of video source apparatuses into the plurality of sub-regions in a one-to-one manner by the video disposition circuit.

13. The operation method of claim 12, wherein when the interactive position information indicates that a position of the interactive event is located in a corresponding sub-region of the plurality of sub-regions, the event coordinate data is sent to the corresponding video source apparatus corresponding to the corresponding sub-region by the position determination circuit.

14. The operation method of claim 11, wherein the step of disposing the plurality of video frames into the display frame comprises:
defining a plurality of stackable windows in the display frame by the video disposition circuit; and
disposing the plurality of video frames respectively from the plurality of video source apparatuses into the plurality of stackable windows in a one-to-one manner by the video disposition circuit.

15. The operation method of claim 14, further comprising:
receiving the interactive position information by the video disposition circuit;
selecting a corresponding window from the plurality of stackable windows as an active window according to the interactive position information by the video disposition circuit; and
pulling the corresponding window to a topmost layer in the plurality of stackable windows by the video disposition circuit when at least part of the corresponding window is covered under other window in the plurality of stackable windows.

16. The operation method of claim 14, wherein when the interactive position information indicates that a position of the interactive event is located in a corresponding window of the plurality of stackable windows, the event coordinate data is sent to the corresponding video source apparatus corresponding to the corresponding window by the position determination circuit.

17. The operation method of claim 11, wherein the interactive position information represents a position of the interactive event in a coordinate space of the display frame.

18. The operation method of claim 17, further comprising:
converting the interactive position information belonging to the coordinate space of the display frame into the event coordinate data belonging to a coordinate space of the video frame of the corresponding video source apparatus by the position determination circuit.

19. The operation method of claim 11, wherein the display module comprises a display screen to receive and display the display frame, and the event detection module comprises a touch panel to sense the interactive event in the display frame so as to obtain the detection signal.

20. The operation method of claim 11, wherein the display module comprises a projection module to receive and display the display frame, and the event detection module comprises a touch projection screen to sense the interactive event in the display frame so as to obtain the detection signal.

21. An operation method of an interactive display system, the interactive display system comprising a video disposition circuit, a display module, an event detection module, an event processing circuit, and a position determination circuit, the operation method comprising:
receiving at least one video frame from at least one video source apparatus by the video disposition circuit;
disposing the at least one video frame into a display frame and outputting frame disposition information by the video disposition circuit;
detecting whether there is more than one video frame respectively from more than one video source apparatus by the video disposition circuit;
receiving and displaying the display frame by the display module;
sensing an interactive event in the display frame and generating a detection signal by the event detection module;
generating interactive position information according to the detection signal by the event processing circuit, wherein the interactive position information represents a position of the interactive event in a coordinate space of the display frame;
selecting a corresponding video source apparatus from a plurality of video source apparatuses according to the interactive position information and the frame disposition information by the position determination circuit when detecting there is more than one video frame respectively from the plurality of video source apparatuses;
converting the interactive position information belonging to the coordinate space of the display frame into event coordinate data belonging to a coordinate space of the video frame of the corresponding video source apparatus by the position determination circuit; and
sending the event coordinate data corresponding to the interactive position information to the corresponding video source apparatus.
